(19) United States
(12) Patent Application Publication
(10) Pub. No.: US 2016/0379781 A1
(43) Pub. Date: Dec. 29, 2016

(54) Thermostat Having Safety Function

(71) Applicant: Hui-ming Kuo, Xiamen City (CN)

(72) Inventor: Hui-ming Kuo, Xiamen City (CN)

(21) Appl. No.: 14/748,249

(22) Filed: Jun. 24, 2015

(51) Int. Cl. H01H 37/32; H01H 37/04

(52) U.S. Cl. CPC H01H 37/32; H01H 37/04

(57) ABSTRACT

A thermostat having a safety function includes a constant temperature mechanism. The constant temperature mechanism includes a metallic lid, an insulation main body coupled to the metallic lid, a dual metallic plate, an insulation push rod leaning against the dual metallic plate, an elastic plate moveably leaning against the insulation push rod, a contact plate movably cooperating with the elastic plate, and two terminals for connecting with a circuit. A safety mechanism is provided between the two terminals of the constant temperature mechanism. The thermostat is compact in structure and has reliable functions and suitable for high power electric appliances to meet the demand of safety effectively.

### BACKGROUND OF THE INVENTION

(a) Technical Field of the Invention

The present invention relates to a thermoswitch, and more particularly to a thermostat having a safety function.

(b) Description of the Prior Art

A thermostat is an essential component for an electric appliance. According to the temperature setting, it can be an adjustable thermostat or a non-adjustable thermostat. In general, the thermostat applied to an electric appliance, such as an electric iron, is an adjustable thermostat with a safety device. This thermostat is provided with a metallic plate and terminals disposed between the edges to form a movable circuit for connection and disconnection. There is no need to redesign the structure of the adjustable thermostat with a safety device. It is achieved by extending the original metallic plate. The current trend is to develop a high power electric iron provided with a non-adjustable thermostat instead of an adjustable thermostat. For the high power electric appliance, the temperate rises rapidly. It is necessary to provide a safety device for the thermostat, such that the electric appliance can be used safely. A common structure on the market is that a fuse is coupled to the thermostat. The reaction speed of the thermostat with a fuse is slow, so this thermostat is not suitable for high power electric appliances.

Accordingly, the inventor of the present invention has devoted himself based on his many years of practical experiences to solve these problems and to develop a fuse-type safety device coupled to a non-adjustable thermostat.

### SUMMARY OF THE INVENTION

The primary object of the present invention is to provide a thermostat having a safety function. The thermostat is safe and suitable for high power electric appliances and compact in structure and has reliable functions.

In order to achieve the aforesaid object, the thermostat having a safety function of the present invention comprises a constant temperature mechanism. The constant temperature mechanism comprises a metallic lid, an insulation main body coupled to the metallic lid, a dual metallic plate disposed on the metallic lid, an insulation push rod leaning against the dual metallic plate, an elastic plate moveably leaning against the insulation push rod, a contact plate movably cooperating with the elastic plate, and two terminals for connecting with a circuit. Wherein, a safety mechanism is provided between the two terminals of the constant temperature mechanism. The safety mechanism comprises a safety elastic plate and an insulation push pin. One end of the insulation push pin is against a fusible material, and another end of the insulation push pin is against the safety elastic plate. The safety elastic plate is controlled by the insulation push pin to be connected between the two terminals of the constant temperature mechanism.

Preferably, the dual metallic plate is located under the insulation main body and disposed on the metallic lid. The insulation push rod is movably disposed in the insulation main body. The elastic plate is disposed above the insulation push rod.

Preferably, the safety mechanism further comprises an upper safety plate. The safety elastic plate is secured on top of the insulation main body and movably cooperates with the upper safety plate. The elastic plate, the contact plate and the upper safety plate are secured on the same axis of the insulation main body. The insulation push pin is located at one side of the insulation main body.

Preferably, the safety elastic plate is formed with an arc cap corresponding in position to the insulation push pin.

Preferably, the elastic plate and the upper safety plate are an integral configuration, with their respective middle portions secured on top of the insulation main body.

Preferably, the joint ends of the elastic plate and the contact plate are provided with contacts each coated with a silvering layer.

Preferably, the upper safety plate includes a terminal plate located at the same axis as the contact plate and a safety plate in contact with the safety elastic plate. The terminal plate and the safety plate are arranged in a configuration having an inclined angle.

Preferably, the safety elastic plate is provided with a contact piece extending outward from the arc cap. An end of the safety plate, corresponding to the contact piece, extends to contact with the contact piece.

Preferably, the joint ends of the contact piece and the safety plate are provided with contacts each coated with a silvering layer.

Preferably, the upper safety plate is directly formed with the terminals. The safety elastic plate is a bent arm. The arc cap is disposed at a bent end of the safety elastic plate. The safety elastic plate is provided with a bent portion to contact with the upper safety plate.

Preferably, the fusible material is coupled to a heating plate of an electric appliance.

Alternatively, the fusible material is directly disposed on the metallic lid.

The thermostat of the present invention has the insulation main body with a special design, namely, both the constant temperature mechanism and the safety mechanism are disposed on the insulation main body in cooperation with the metallic lid for the fuse-type safety mechanism to be coupled on the thermostat effectively. The thermostat of the present invention is compact in structure and has reliable functions and is suitable for high power electric appliances to meet the demand of safety

### BRIEF DESCRIPTION OF THE DRAWINGS

FIG. 1 is an exploded view according to a first embodiment of the present invention;

FIG. 2 is a top view according to the first embodiment of the present invention;

FIG. 3A is a sectional view showing that the safety mechanism and the constant temperature mechanism are in a connection state according to the first embodiment of the present invention;

FIG. 3B is a side view showing that the safety mechanism and the constant temperature mechanism are in a connection state according to the first embodiment of the present invention;

FIG. 4A is a sectional view showing that the safety mechanism is in a connection state and the constant temperature mechanism is in a disconnection state according to the first embodiment of the present invention;

FIG. 4B is a side view showing that the safety mechanism is in a connection state and the constant temperature mechanism is in a disconnection state according to the first embodiment of the present invention;

FIG. 5A is a sectional view showing that the safety mechanism and the constant temperature mechanism are in a disconnection state according to the first embodiment of the present invention;

FIG. 5B is a side view showing that the safety mechanism and the constant temperature mechanism are in a disconnection state according to the first embodiment of the present invention;

FIG. 6A is a sectional view showing that the safety mechanism is in a disconnection state and the constant temperature mechanism is in a connection state according to the first embodiment of the present invention;

FIG. 6B is a side view showing that the safety mechanism is in a disconnection state and the constant temperature mechanism is in a connection state according to the first embodiment of the present invention;

FIG. 7 is an exploded view according to a second embodiment of the present invention;

FIG. 8 is a top view according to the second embodiment of the present invention;

FIG. 9A is a sectional view showing that the safety mechanism and the constant temperature mechanism are in a connection state according to the second embodiment of the present invention;

FIG. 9B is a side view showing that the safety mechanism and the constant temperature mechanism are in a connection state according to the second embodiment of the present invention;

FIG. 10A is a sectional view showing that the safety mechanism is in a connection state and the constant temperature mechanism is in a disconnection state according to the second embodiment of the present invention;

FIG. 10B is a side view showing that the safety mechanism is in a connection state and the constant temperature mechanism is in a disconnection state according to the second embodiment of the present invention;

FIG. 11A is a sectional view showing that the safety mechanism is in a disconnection state and the constant temperature mechanism is in a connection state according to the second embodiment of the present invention;

FIG. 11B is a side view showing that the safety mechanism is in a disconnection state and the constant temperature mechanism is in a connection state according to the second embodiment of the present invention;

FIG. 12A is a sectional view showing that the safety mechanism and the constant temperature mechanism are in a disconnection state according to the second embodiment of the present invention;

FIG. 12B is a side view showing that the safety mechanism and the constant temperature mechanism are in a disconnection state according to the second embodiment of the present invention;

FIG. 13 is an exploded view according to a third embodiment of the present invention;

FIG. 14 is a top view according to the third embodiment of the present invention;

FIG. 15A is a sectional view showing that the safety mechanism and the constant temperature mechanism are in a connection state according to the third embodiment of the present invention;

FIG. 15B is a side view showing that the safety mechanism and the constant temperature mechanism are in a connection state according to the third embodiment of the present invention;

FIG. 16A is a sectional view showing that the safety mechanism is in a connection state and the constant temperature mechanism is in a disconnection state according to the third embodiment of the present invention;

FIG. 16B is a side view showing that the safety mechanism is in a connection state and the constant temperature mechanism is in a disconnection state according to the third embodiment of the present invention;

FIG. 17A is a sectional view showing that the safety mechanism is in a disconnection state and the constant temperature mechanism is in a connection state according to the third embodiment of the present invention;

FIG. 17B is a side view showing that the safety mechanism is in a disconnection state and the constant temperature mechanism is in a connection state according to the third embodiment of the present invention;

FIG. 18A is a sectional view showing that the safety mechanism and the constant temperature mechanism are in a disconnection state according to the third embodiment of the present invention;

FIG. 18B is a side view showing that the safety mechanism and the constant temperature mechanism are in a disconnection state according to the third embodiment of the present invention; and

FIG. 19 is a sectional view according to a fourth embodiment of the present invention.

### DETAILED DESCRIPTION OF THE PREFERRED EMBODIMENTS

Embodiments of the present invention will now be described, by way of example only, with reference to the accompanying drawings.

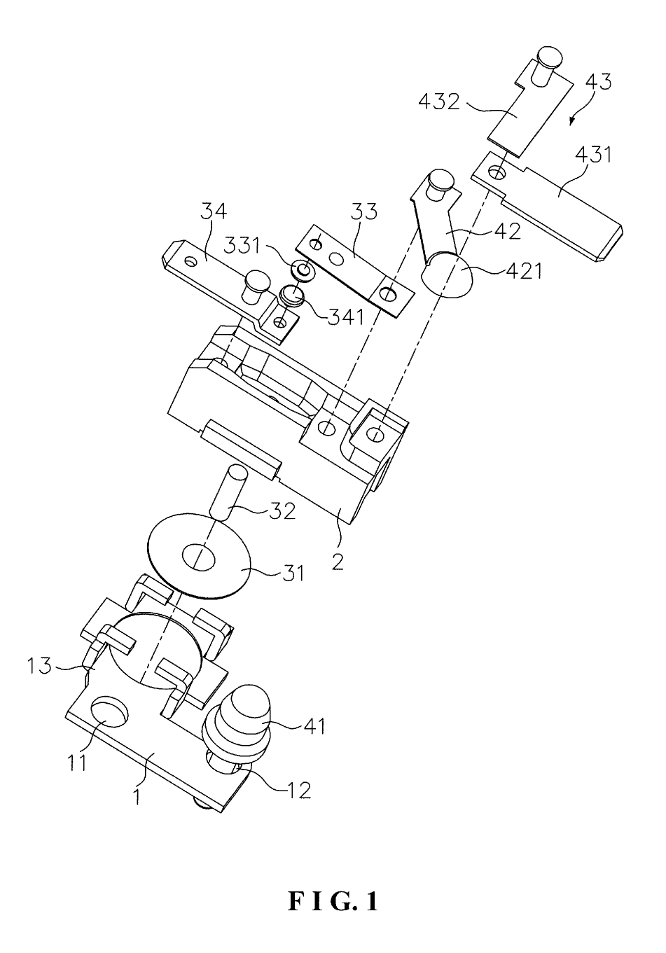

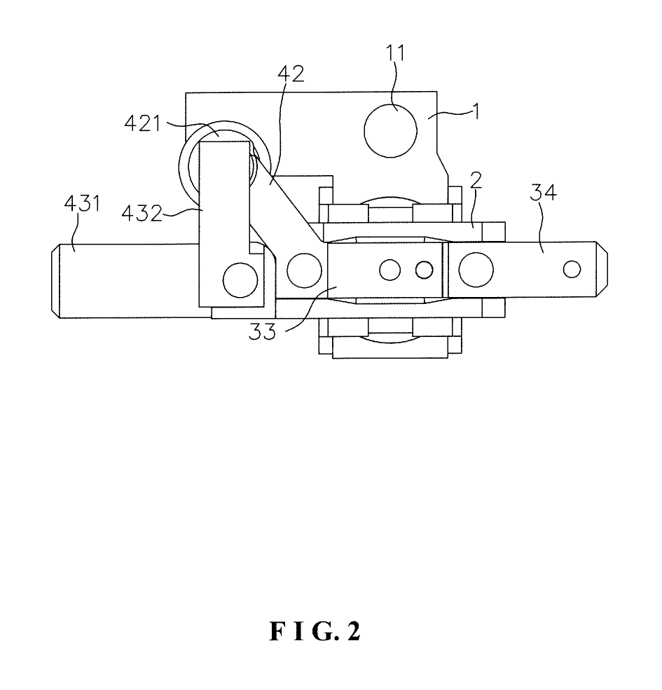

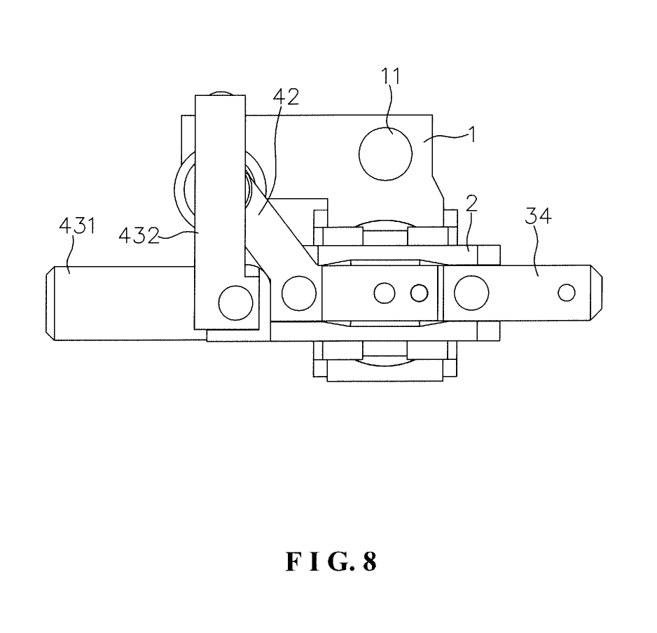

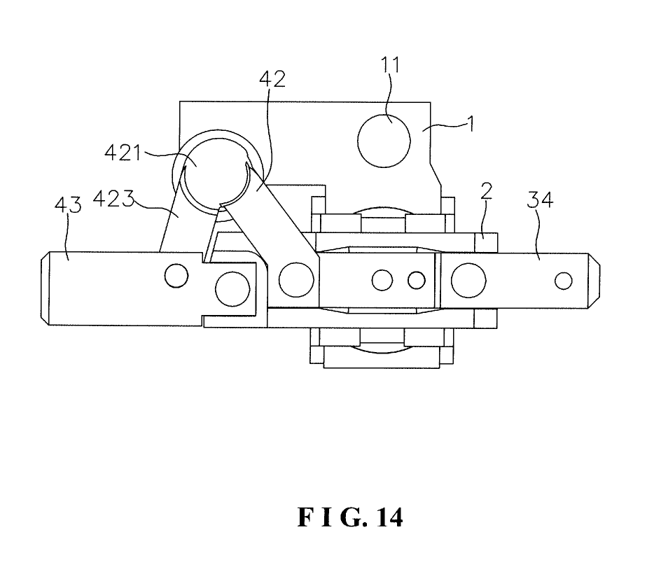

As shown in FIG. 1 to FIG. 19, the present invention discloses a thermostat having a safety function. The thermostat comprises a constant temperature mechanism 3. The constant temperature mechanism 3 comprises a metallic lid 1, an insulation main body 2 coupled to the metallic lid 1, a dual metallic plate 31 disposed on the metallic lid 1, an insulation push rod 32 leaning against the dual metallic plate 31, an elastic plate 33 moveably leaning against the insulation push rod 32, a contact plate 34 movably cooperating with the elastic plate 33, and two terminals for connecting with a circuit. The feature of the present invention is that a safety mechanism 4 is provided between the two terminals of the constant temperature mechanism 3. The safety mechanism 4 comprises a safety elastic plate 42 and an insulation push pin 41. One end of the insulation push pin 41 is against a fusible material 5. In this embodiment, the fusible material 5 is coupled to a heating plate of an electric appliance. Another end of the insulation push pin 41 is against the safety elastic plate 42. The safety elastic plate 42 is controlled by the insulation push pin 41 to be connected between the two terminals of the constant temperature mechanism 3.

In this embodiment, the thermostat having a safety function is locked on a heating plate of an electric appliance as an example.

The constant temperature mechanism 3 comprises a dual metallic plate 31 disposed on an aluminum lid 1 and located under an insulation main body 2, an insulation push rod 32 disposed on the dual metallic plate 31 and movable in the insulation main body 2, an elastic plate 33 disposed above the insulation push rod 32, and a contact plate 34 movably cooperating with the elastic plate 33. The contact plate 34 can be directly formed with the terminals. The elastic plate 33 and the contact plate 34 are secured on top of the insulation main body 2, respectively.

The safety mechanism 4 comprises an insulation push pin 41 passing through the metallic lid 1, a safety elastic plate 42 held by the insulation push pin 41 and secured on top of the insulation main body 2, and an upper safety plate 43 movably cooperating with the safety elastic plate 42. The upper safety plate 43 can be directly formed with the terminals. The bottom of the insulation push pin 41 is provided with the fusible material 5.

The elastic plate 33 and the upper safety plate 43 can be an integral configuration, with their respective middle portions secured on top of the insulation main body 2.

The insulation main body 2, the insulation push rod 32, and the insulation push pin 41 can be made of a ceramic material.

The metallic lid 1 can be made of an aluminum material. The metallic lid 1 is provided with a lock hole 11, a through hole 12 for the insulation push pin 41 to pass therethrough, and a plate surface 13 in cooperation with the dual metallic plate 31 and the insulation main body 2.

The insulation main body 2 is a base body. The elastic plate 33, the contact plate 34, and the upper safety plate 43 are secured on the same axis (coaxially). The insulation push pin 41 is located at one side of the insulation main body 2.

FIG. 1 to FIG. 6B shows the thermostat having a safety function according to a first embodiment of the present invention. Wherein, the elastic plate 33 and the safety elastic plate 42 are formed with a bent arm configuration having an inclined angle. The fixed ends of both are secured on the insulation main body 2 by the same rivet. The joint ends of the elastic plate 33 and the contact plate 34 are provided with contacts 331, 341 each coated with a silvering layer. The safety elastic plate 42 is formed with an arc cap 421 corresponding in position to the insulation push pin 41, ensuring the stability of engagement between the insulation push pin 41 and the safety elastic plate 42. The upper safety plate 43 includes a terminal plate 431 located at the same axis as the contact plate 34 and a safety plate 432 in contact with the safety elastic plate 42. The fixed ends of the terminal plate 431 and the safety plate 432 are secured on the insulation main body 2 by the same rivet. The terminal plate 431 and the safety plate 432 are arranged in a configuration having an inclined angle. The arc cap 421 of the safety elastic plate 42 is in contact with the safety plate 432.

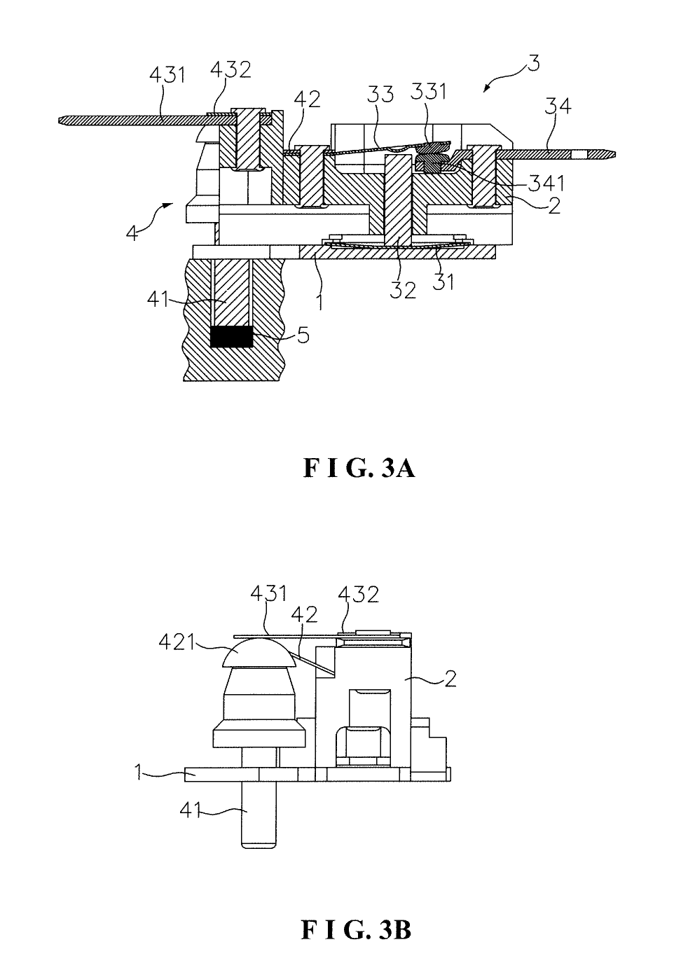

As shown in FIG. 3A and FIG. 3B, in a normal state, the insulation push pin 41 of the safety mechanism 4 holds against the safety elastic plate 42 to contact with the upper safety plate 43. The elastic plate 33 of the constant temperature mechanism 3 and the contact plate 34 are also in a contact connection state. The insulation push rod 32 and the elastic plate 33 are in a disconnection state.

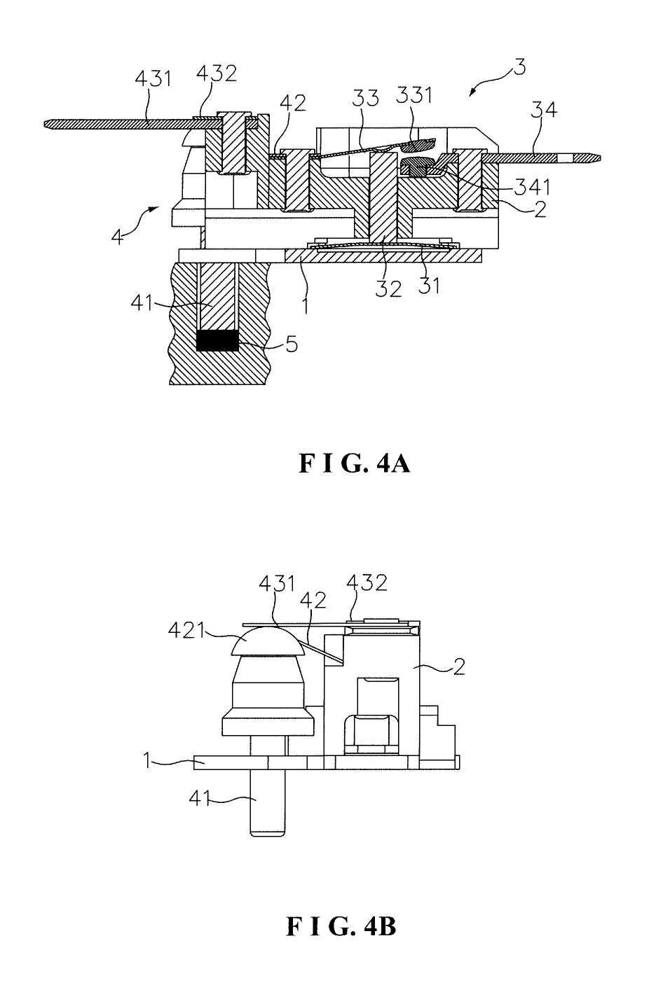

As shown in FIG. 4A and FIG. 4B, when the electric appliance in an electrified state reaches a predetermined temperature, the dual metallic plate 31 of the constant temperature mechanism 3 is deformed by heating to push the insulation push rod 32 up and the elastic plate 33 is pushed to disengage from the contact plate 34. At this time, the safety mechanism 4 is in a connection state and the constant temperature mechanism 3 is in a disconnection state.

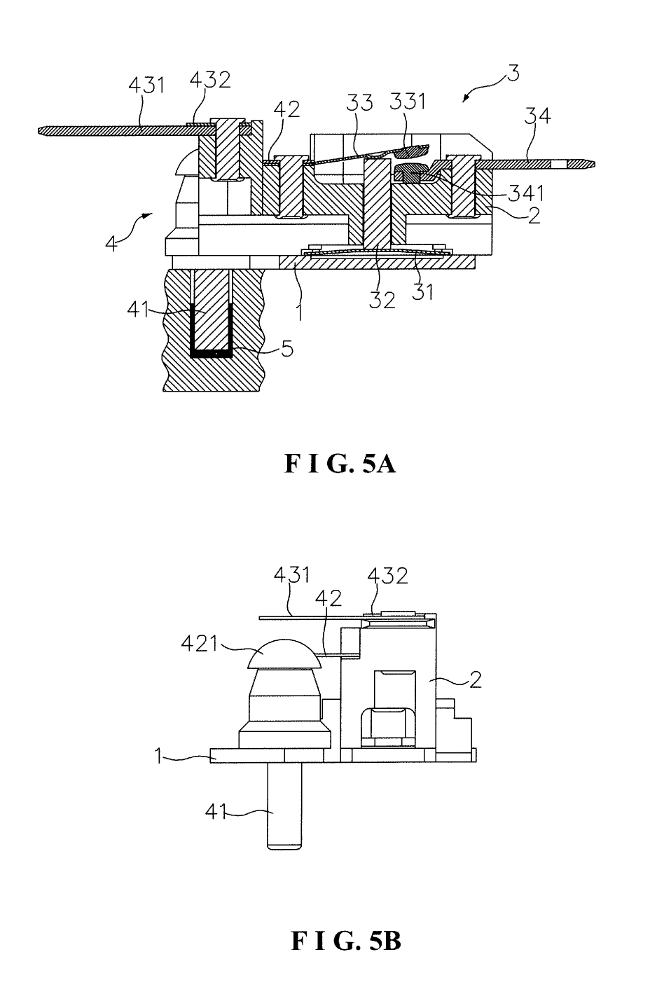

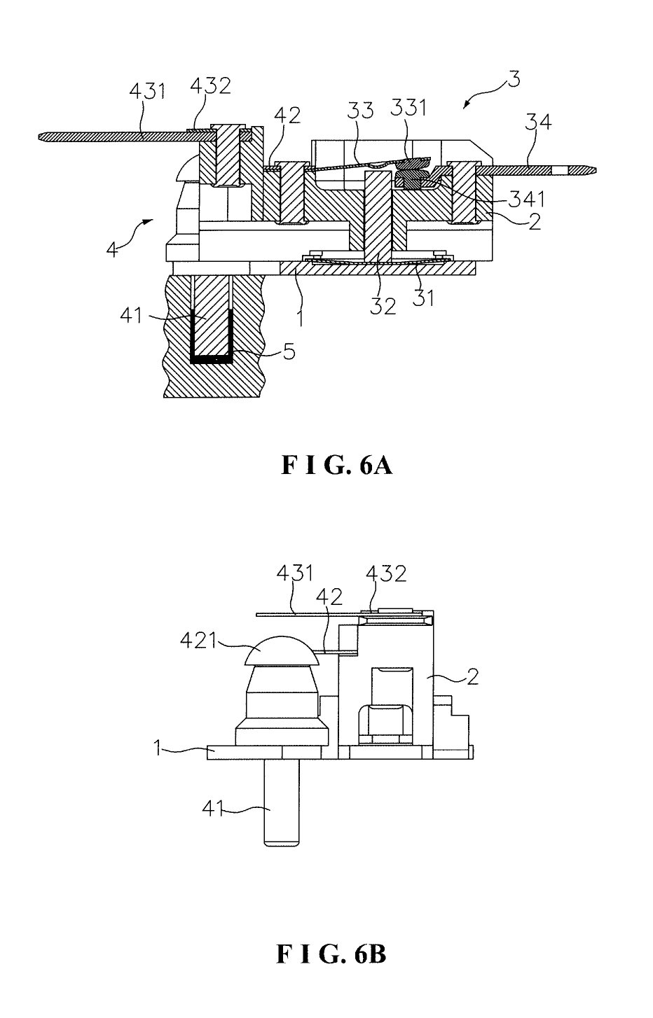

As shown in FIG. 5A to FIG. 6B, when the temperature of the electric appliance rises and exceeds the predetermined temperature and the constant temperature mechanism 3 malfunctions in a disconnection state or in a connection state, the fusible material 5 at the bottom of the insulation push pin 41 will fuse. The support of the bottom of the insulation push pin 41 will lose, so the insulation push pin 41 will move down with its gravity. At this time, the insulation push pin 41 loses the holding force for the safety elastic plate 42 to contact with the upper safety plate 43, such that the safety elastic plate 42 disengages from the upper safety plate 43 by its restoring force of deformation to cut off the circuit for providing a safety function, preventing the temperature of the electric appliance from rising to cause a danger.

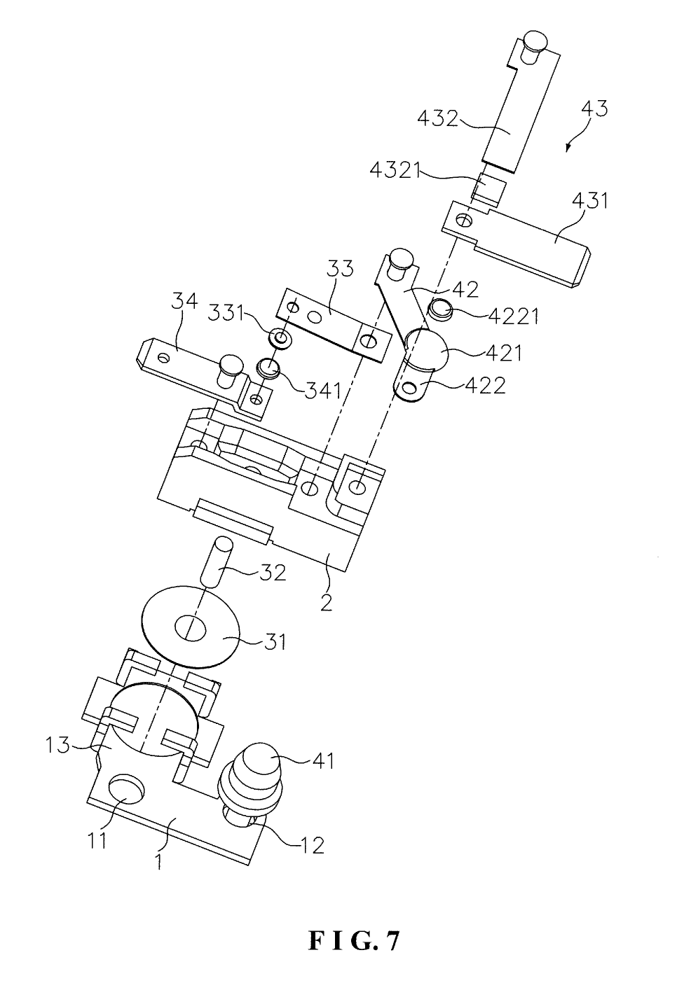

FIG. 7 to FIG. 12B shows the thermostat having a safety function according to a second embodiment of the present invention. The second embodiment is substantially similar to the first embodiment with the exceptions described hereinafter. The safety elastic plate 42 is provided with a contact piece 422 extending outward from the arc cap 421. An end of the safety plate 432, corresponding to the contact piece 422, extends to contact with the contact piece 422. The joint ends of the contact piece 422 and the safety plate 432 are provided with contacts 4221, 4321 each coated with a silvering layer.

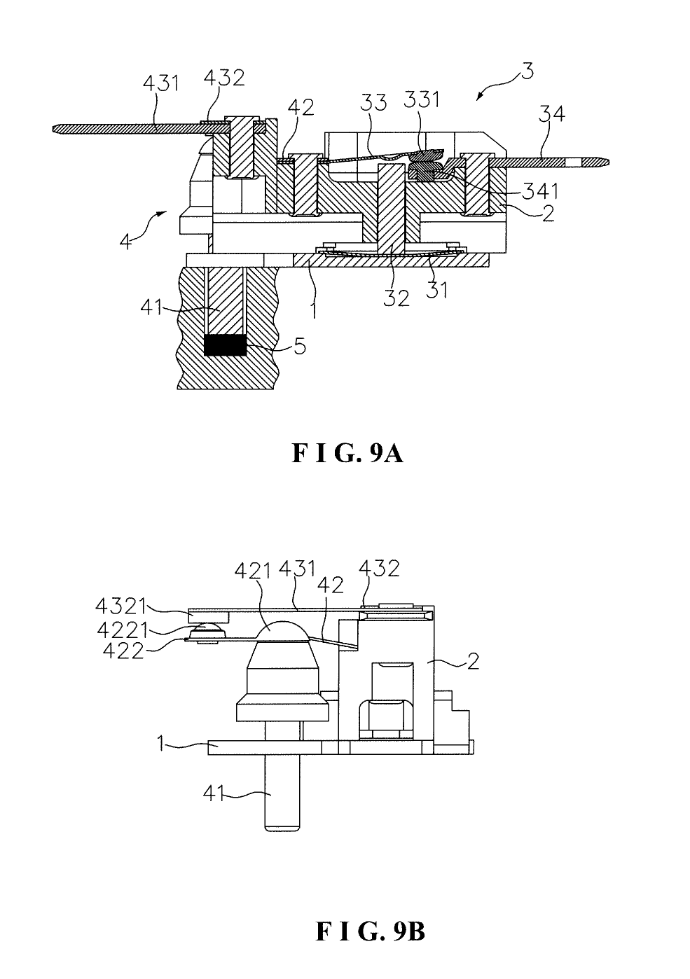

As shown in FIG. 9A and FIG. 9B, in a normal state, the insulation push pin 41 of the safety mechanism 4 holds against the safety elastic plate 42 to contact with the upper safety plate 43. The elastic plate 33 of the constant temperature mechanism 3 and the contact plate 34 are also in a contact connection state. The insulation push rod 32 and the elastic plate 33 are in a disconnection state.

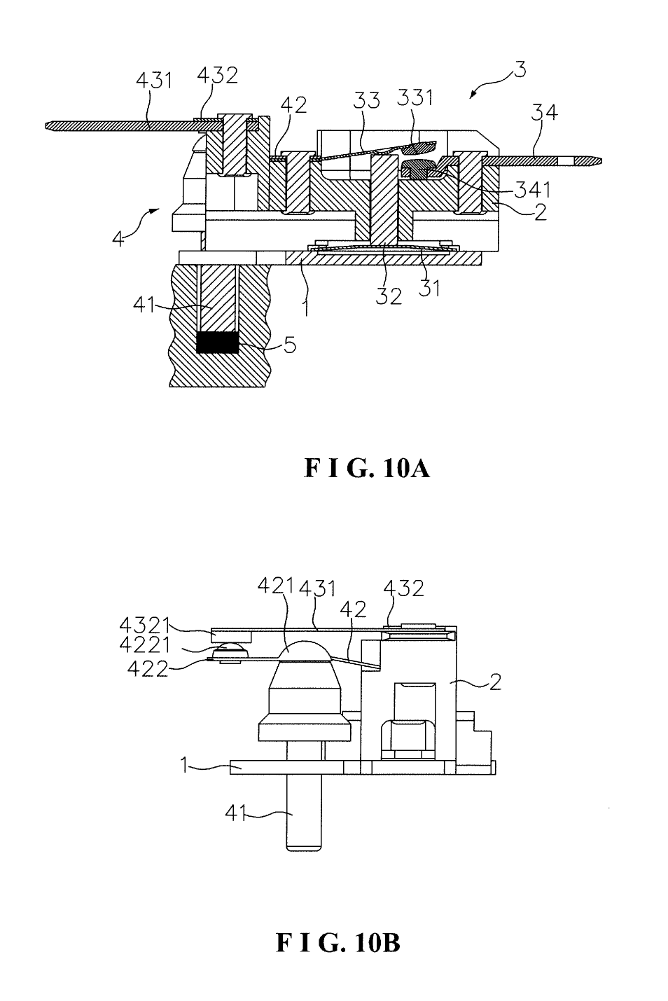

As shown in FIG. 10A and FIG. 10B, when the electric appliance in an electrified state reaches a predetermined temperature, the dual metallic plate 31 of the constant temperature mechanism 3 is deformed by heating to push the insulation push rod 32 up and the elastic plate 33 is pushed to disengage from the contact plate 34. At this time, the safety mechanism 4 is in a connection state and the constant temperature mechanism 3 is in a disconnection state.

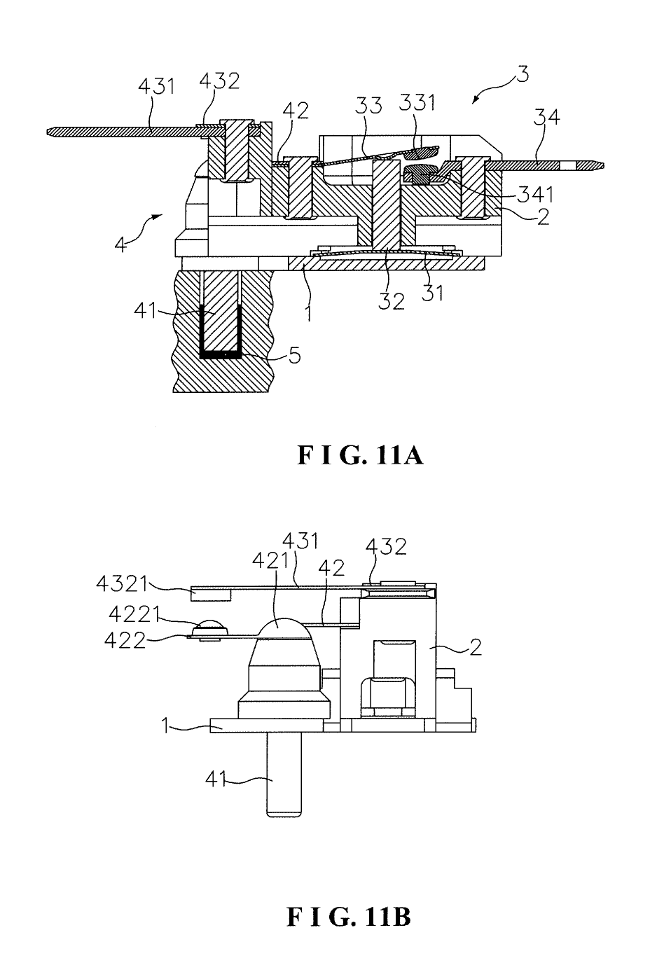

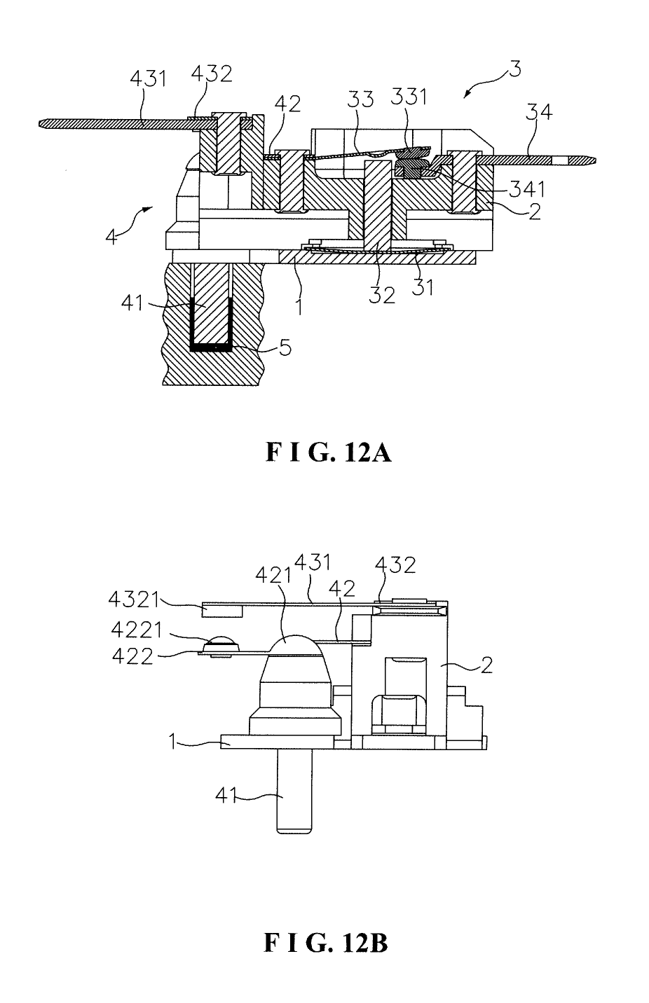

As shown in FIG. 11A to FIG. 12B, when the temperature of the electric appliance rises and exceeds the predetermined temperature and the constant temperature mechanism 3 malfunctions in a disconnection state or in a connection state, the fusible material 5 at the bottom of the insulation push pin 41 will fuse. The support of the bottom of the insulation push pin 41 will lose, so the insulation push pin 41 will move down with its gravity. At this time, the insulation push pin 41 loses the holding force for the safety elastic plate 42 to contact with the upper safety plate 43, such that the safety elastic plate 42 disengages from the upper safety plate 43 by its restoring force of deformation to cut off the circuit for providing a safety function, preventing the temperature of the electric appliance from rising to cause a danger.

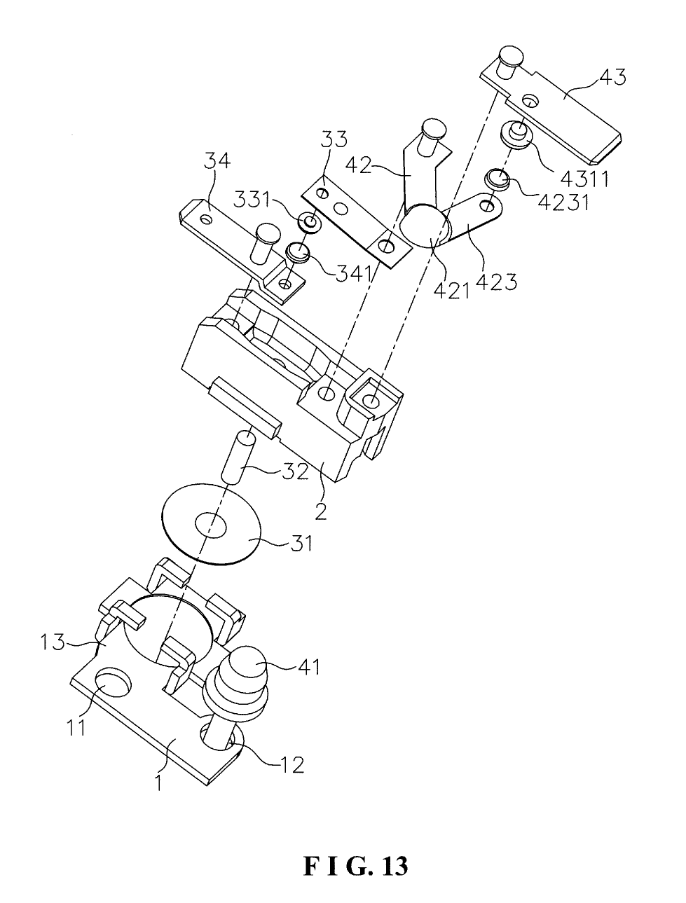

FIG. 13 to FIG. 18B shows the thermostat having a safety function according to a third embodiment of the present invention. The third embodiment is substantially similar to the first embodiment with the exceptions described hereinafter. The upper safety plate 43 is directly formed with the terminals. The safety elastic plate 42 is a bent aim. The arc cap 421 is disposed at a bent end of the safety elastic plate 42. The safety elastic plate 42 is provided with a bent portion 423 to contact with the upper safety plate 43. The joint ends of the bent portion 423 and the upper safety plate 43 are provided with contacts 4231, 4311 each coated with a silvering layer.

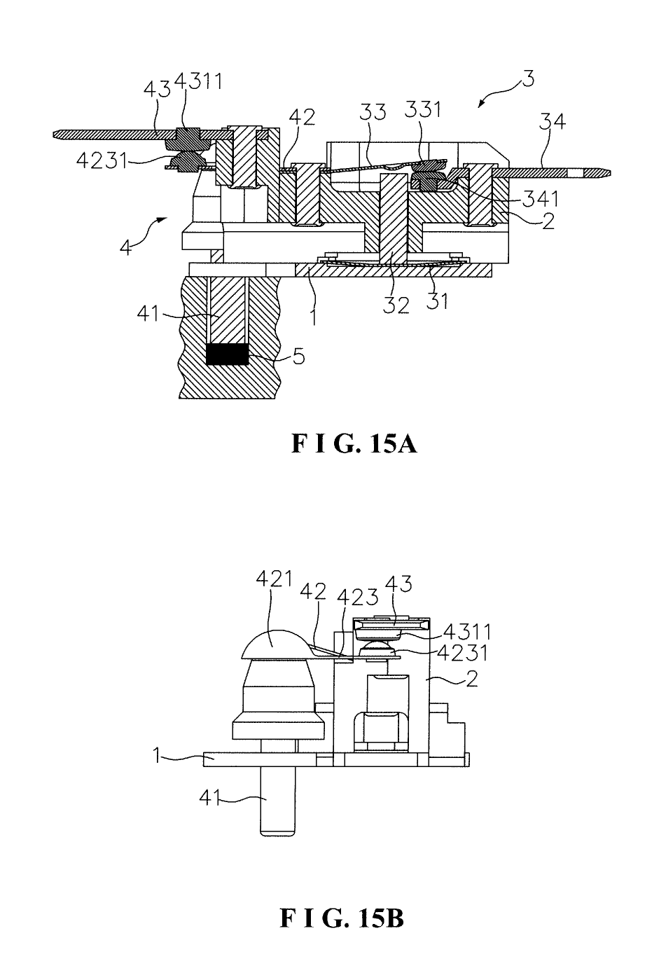

As shown in FIG. 15A and FIG. 15B, in a normal state, the insulation push pin 41 of the safety mechanism 4 holds against the safety elastic plate 42 to contact with the upper safety plate 43. The elastic plate 33 of the constant temperature mechanism 3 and the contact plate 34 are also in a contact connection state. The insulation push rod 32 and the elastic plate 33 are in a disconnection state.

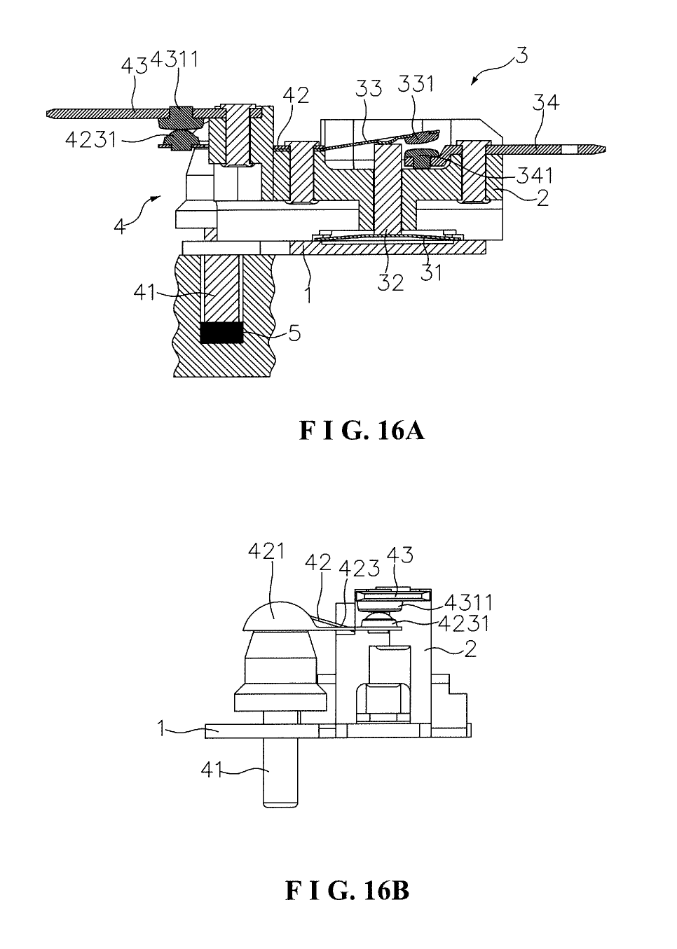

As shown in FIG. 16A and FIG. 16B, when the electric appliance in an electrified state reaches a predetermined temperature, the dual metallic plate 31 of the constant temperature mechanism 3 is deformed by heating to push the insulation push rod 32 up and the elastic plate 33 is pushed to disengage from the contact plate 34. At this time, the safety mechanism 4 is in a connection state and the constant temperature mechanism 3 is in a disconnection state.

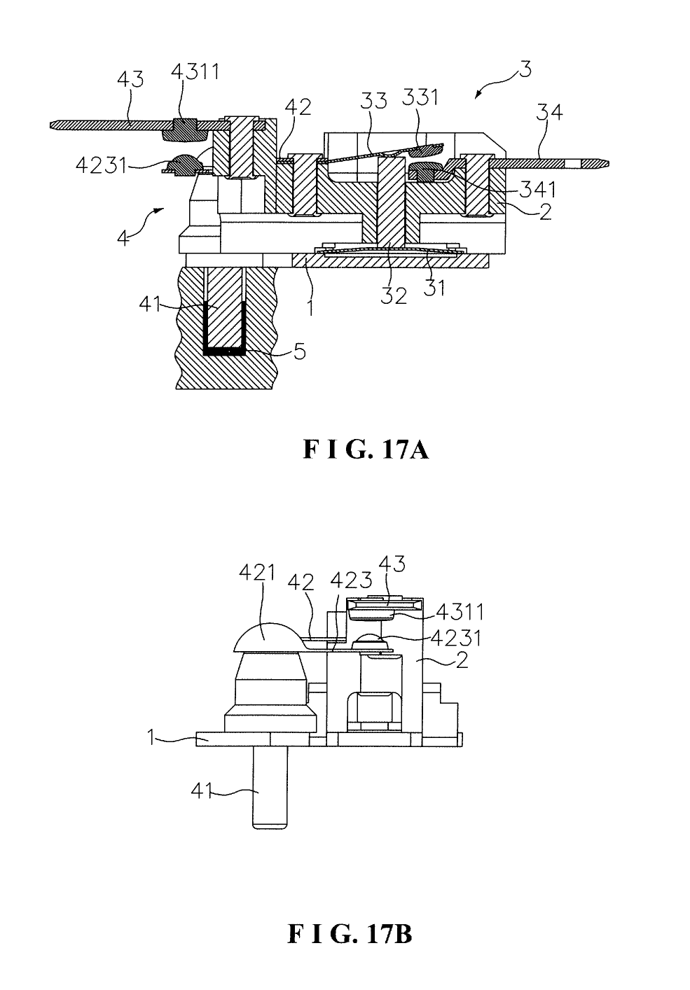

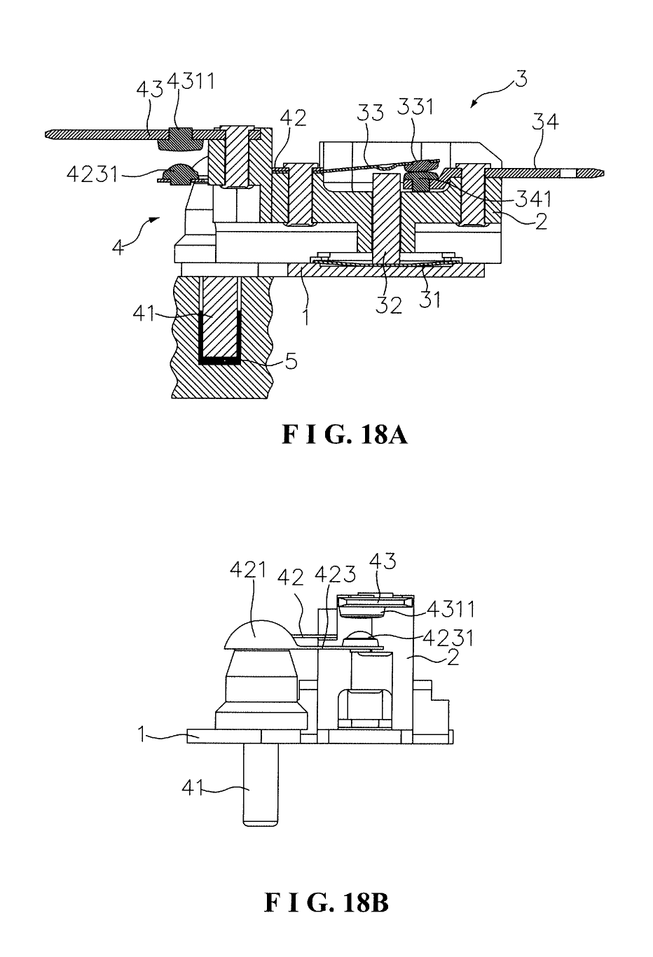

As shown in FIG. 17A to FIG. 18B, when the temperature of the electric appliance rises and exceeds the predetermined temperature and the constant temperature mechanism 3 malfunctions in a disconnection state or in a connection state, the fusible material 5 at the bottom of the insulation push pin 41 will fuse. The support of the bottom of the insulation push pin 41 will lose, so the insulation push pin 41 will move down with its gravity. At this time, the insulation push pin 41 loses the holding force for the safety elastic plate 42 to contact with the upper safety plate 43, such that the safety elastic plate 42 disengages from the upper safety plate 43 by its restoring force of deformation to cut off the circuit for providing a safety function, preventing the temperature of the electric appliance from rising to cause a danger.

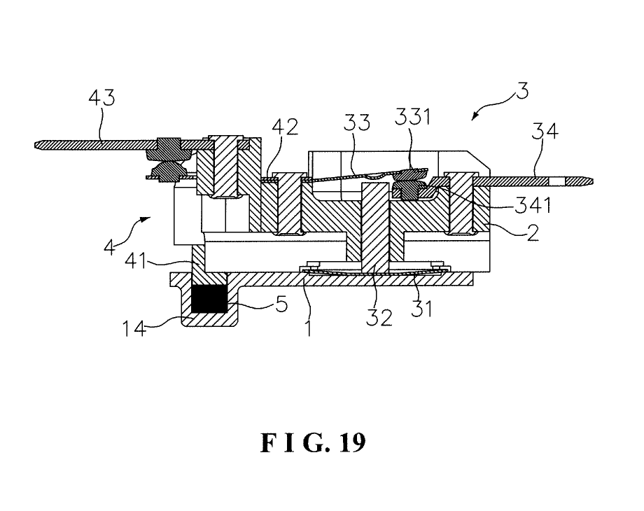

As shown in FIG. 19, the fusible material 5 to hold against the insulation push pin 41 of the safety mechanism 4 can be directly disposed on the metallic lid 1. The metallic lid 1 is provided with a countersunk seat 14 to accommodate the fusible material 5 therein. This also achieves a safety function.

The thermostat of the present invention has the insulation main body 2 with a special design, namely, both the constant temperature mechanism 3 and the safety mechanism 4 are disposed on the insulation main body 2 in cooperation with the metallic lid 1 for the fuse-type safety mechanism 4 to be coupled on the thermostat effectively. The thermostat of the present invention is compact in structure and has reliable functions and is suitable for high power electric appliances to meet the demand of safety effectively.

Although particular embodiments of the present invention have been described in detail for purposes of illustration, various modifications and enhancements may be made without departing from the spirit and scope of the present invention. Accordingly, the present invention is not to be limited except as by the appended claims.

I claim:

1. A thermostat having a safety function, comprising a constant temperature mechanism, the constant temperature mechanism comprising a metallic lid., an insulation main body coupled to the metallic lid, a dual metallic plate disposed on the metallic lid, an insulation push rod leaning against the dual metallic plate, an elastic plate moveably leaning against the insulation push rod, a contact plate movably cooperating with the elastic plate, and two terminals for connecting with a circuit, characterized by: a safety mechanism being provided between the two terminals of the constant temperature mechanism, the safety mechanism comprising a safety elastic plate and an insulation push pin, one end of the insulation push pin being against a fusible material, another end of the insulation push pin being against the safety elastic plate, the safety elastic plate being controlled by the insulation push pin to be connected between the two terminals of the constant temperature mechanism.

2. The thermostat having a safety function as claimed in claim 1, wherein the dual metallic plate is located under the insulation main body and disposed on the metallic lid, the insulation push rod is movably disposed in the insulation main body, and the elastic plate is disposed above the insulation push rod.

3. The thermostat having a safety function as claimed in claim 2, wherein the safety mechanism further comprises an upper safety plate, the safety elastic plate is secured on top of the insulation main body and movably cooperates with the upper safety plate, the elastic plate, the contact plate and the upper safety plate are secured on a same axis of the insulation main body, and the insulation push pin is located at one side of the insulation main body.

4. The thermostat having a safety function as claimed in claim 1, wherein the safety elastic plate is formed with an arc cap corresponding in position to the insulation push pin.

5. The thermostat having a safety function as claimed in claim 3, wherein the elastic plate and the upper safety plate are an integral configuration, with respective middle portions secured on top of the insulation main body.

6. The thermostat having a safety function as claimed in claim 1, wherein joint ends of the elastic plate and the contact plate are provided with contacts each coated with a silvering layer.

7. The thermostat having a safety function as claimed in claim 3, wherein the upper safety plate includes a terminal plate located at the same axis as the contact plate and a safety plate in contact with the safety elastic plate, and the terminal plate and the safety plate are arranged in a configuration having an inclined angle.

8. The thermostat having a safety function as claimed in claim 7, wherein the safety elastic plate is provided with a contact piece extending outward from the arc cap, and an end of the safety plate, corresponding to the contact piece, extends to contact with the contact piece.

9. The thermostat having a safety function as claimed in claim 8, wherein joint ends of the contact piece and the safety plate are provided with contacts each coated with a silvering layer.

10. The thermostat having a safety function as claimed in claim 3, wherein the upper safety plate is directly formed with the terminals, the safety elastic plate is a bent arm, the arc cap is disposed at a bent end of the safety elastic plate, and the safety elastic plate is provided with a bent portion to contact with the upper safety plate.

11. The thermostat having a safety function as claimed in claim 1, wherein the fusible material is coupled to a heating plate of an electric appliance.

12. The thermostat having a safety function as claimed in claim 1, wherein the fusible material is directly disposed on the metallic lid.
